(19) United States
(12) Patent Application Publication
(10) Pub. No.: US 2007/0166693 A1
(43) Pub. Date: Jul. 19, 2007

(54) Inaudible midi interpretation device

(76) Inventors: Carlos J. Blas, Pflugerville, TX (US); Jennifer Nicole Monk, Austin, TX (US)

Correspondence Address: IBM CORP (YA);C/O YEE & ASSOCIATES PC, P.O. BOX 802333, DALLAS, TX, 75380, US

(21) Appl. No.: 11/334,675

(22) Filed: Jan. 18, 2006

(51) Int. Cl. G09B 25/00

(52) U.S. Cl. 434/407

(57) ABSTRACT

A computer implemented method, apparatus, and computer program usable program code for transmitting information from a musical instrument digital interface file to a device adapted to provide tactile output. Tactile information is output from the device, wherein the tactile information corresponds to the information from the musical instrument digital interface file.

### BACKGROUND OF THE INVENTION

1. Field of the Invention

The present invention relates generally to tactile devices and particularly to tactile devices for the blind. Still more particularly, the present invention relates to a method and apparatus for matching the link speed of a controller with the link speed of a controlled device.

2. Description of the Related Art

Blind musicians often have difficulty reading music while simultaneously playing their instrument. To read music, the blind musician runs their fingers over a series of Braille characters and then must play what is read. As a result, for all practical purposes a blind musician slowly learns a musical piece by touching the series of Braille characters and then practicing the notes read. After learning the musical piece, the musician then plays the musical piece from memory.

For these reasons, blind musicians may become frustrated by the time required to learn even relatively simple pieces of music. The problem is exacerbated when the piece of music is particularly long or complex.

In modern times, blind musicians can take advantage of computer technology to more quickly learn and play written music. For example, a blind musician can cause a piece of music to be played through speakers on a computer. The musician can then playback the music from hearing the piece rather than having to touch Braille characters. However, this solution is inadequate for complex music or if the blind musician does not have a good enough ear to hear and then play-back the music. A blind musician can also use a musical instrument digital interface (MIDI) device, in conjunction with other software, to automatically translate what the musician plays on a musical instrument into sheet music. A musical instrument digital interface is a standard protocol for communication between musical instruments and a computer. The term MIDI or musical instrument digital interface also often refers to a file format for storing musical instrument digital interface commands. This type of file format is known as a musical instrument digital interface file or MIDI file. Although musical instrument digital interface technology does aid a blind person to transcribe music or hear music, to date no device allows a blind person to read music while simultaneously playing a musical instrument.

### SUMMARY OF THE INVENTION

The aspects of the present invention provide a computer implemented method, apparatus, and computer program usable program code for transmitting information from a musical instrument digital interface file to a device adapted to provide tactile output. Tactile information is output from the device, wherein the tactile information corresponds to the information from the musical instrument digital interface file.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is a block diagram of a data processing system in which aspects of the present invention may be implemented, in accordance with an illustrative example of the present invention;

FIG. 3 shows a human playing a musical instrument, in accordance with an illustrative example of the present invention;

FIG. 4 shows a tactile device for transmitting information from a musical instrument digital interface file, in accordance with an illustrative example of the present invention;

FIG. 5 shows a tactile device for transmitting information from a musical instrument digital interface file, in accordance with an illustrative example of the present invention;

FIG. 6 shows a block diagram of a tactile device, in accordance with an illustrative example of the present invention;

FIG. 7 shows a flowchart of converting data in a MIDI file into a pin configuration in a tactile device, in accordance with an illustrative example of the present invention; and

FIG. 8 shows a set of Braille characters representing musical notations.

### DETAILED DESCRIPTION OF THE PREFERRED EMBODIMENT

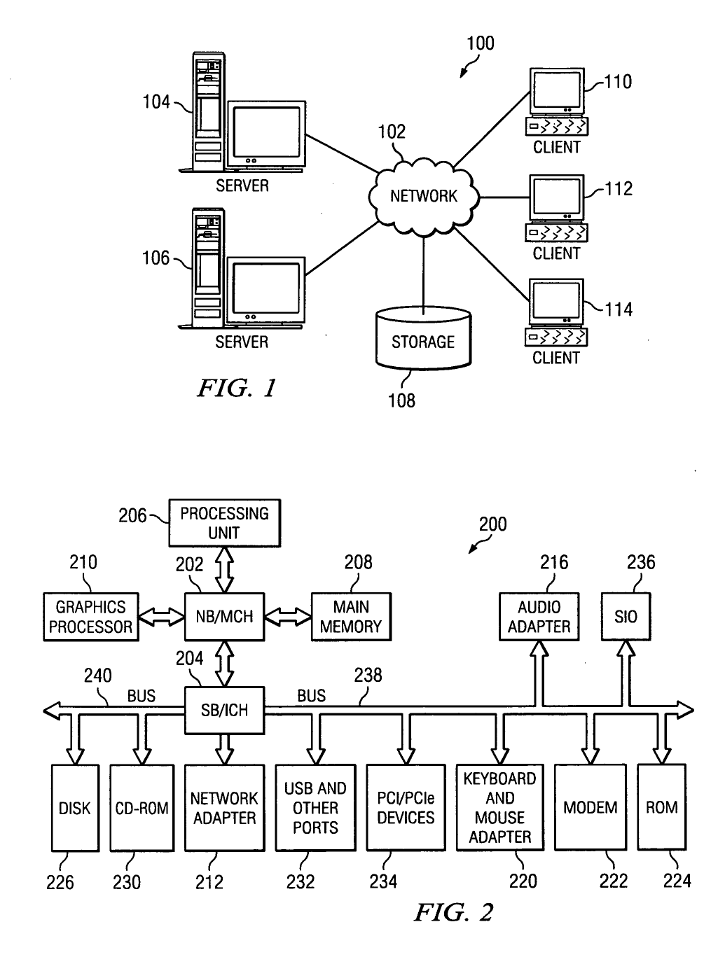

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 is a pictorial representation of a network of data processing systems in which aspects of the present invention may be implemented. Network data processing system 100 is a network of computers or data processing systems in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

FIG. 2 is a block diagram of a data processing system in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for transmission of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention provide a computer implemented method, apparatus, and computer program usable program code for transmitting information from a musical instrument digital interface file to a device adapted to provide tactile output. Tactile information is output from the device, wherein the tactile information corresponds to the information from the musical instrument digital interface file. In an illustrative example, the tactile information is output in the form of a Braille character. As time progresses, the device thereby outputs a series of Braille characters. In this manner, standard Braille musical notation can be communicated to a blind musician. In other examples, the device can output characters in other information systems besides Braille. For example, the characters can be from alphanumeric actual letters or known musical symbols.

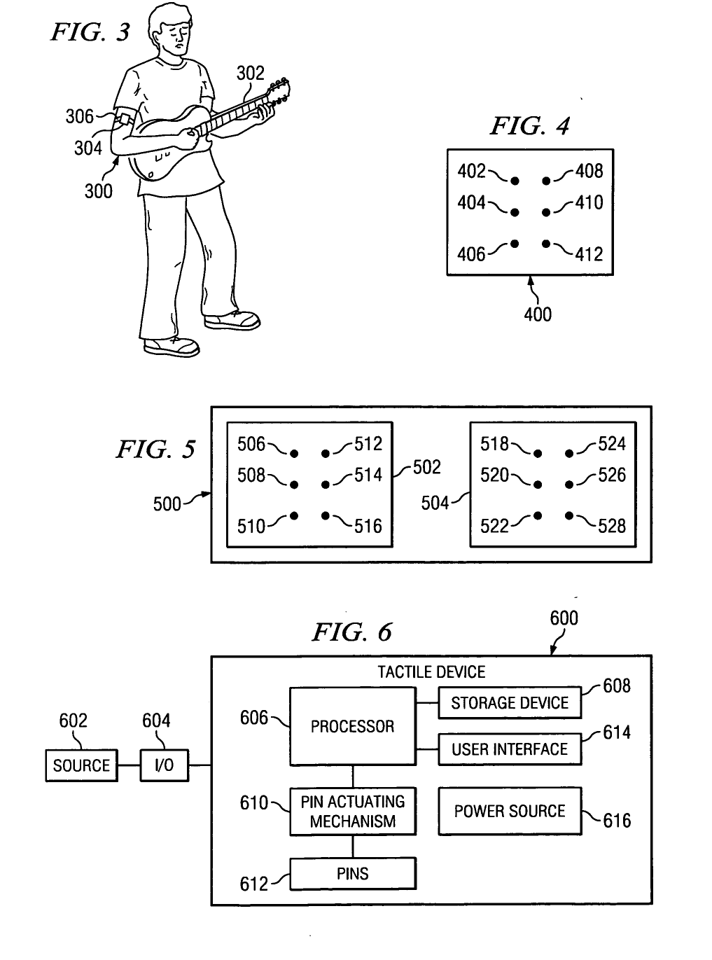

FIG. 3 shows a human playing a musical instrument, in accordance with an illustrative example of the present invention. In the illustrative example shown, human 300 is playing musical instrument 302. Musical instrument 302 is shown as a guitar; however, musical instrument 302 may be any type of musical instrument, such as, for example, a horn, flute, drum, violin, bass, piano, bassoon, oboe, clarinet, saxophone, or any other kind of musical instrument.

Tactile device 304 is attached to the arm of human 300. Tactile device 304 is adapted to provide tactile output to human 300. Tactile device 304 can provide tactile output in a variety of forms, including using a number of pins as shown in FIG. 4 and FIG. 5, using an interchangeable stamp with different symbols, or by using any other means for providing tactile sensations to a user with sufficient detail that the user can discern a character.

Tactile device 304 can include strap 306. Any suitable method of attaching strap 306 to tactile device 304 can be used, and any suitable method of attaching strap 306 to human 300 also can be used. For example, strap 306 can be glued or tied to tactile device 304, wrapped around the arm of human 300, and subsequently secured by using hook and loop fasteners, such as VELCRO®, or by using a buckle attached to strap 306. Thus, strap 306 is a means for securing tactile device 304 to human 300. In addition, any suitable device for securing tactile device 304 to human 300 can replace strap 306. Accordingly, a means for securing tactile device 304 to human 300 also includes a belt, an adjustable band, a flexible strap, an expandable strap, a glue, or any other device or substance for securing tactile device 304 to human 300. In the illustrative example shown, tactile device 304 directly contacts the skin of human 300; however, tactile device may be worn over a shirt, fabric, or other clothing so long as human 300 can sense the detailed shapes that tactile device 304 outputs.

FIG. 4 shows a tactile device for transmitting information from a musical instrument digital interface file, in accordance with an illustrative example of the present invention. Tactile device 400 can be tactile device 304 shown in FIG. 3. In the illustrative examples shown herein, tactile device 400 includes or is connected to a computer-usable medium, such as memory 208, disk 226, or CD-ROM 230 in FIG. 2, which in turn can be a part of data processing system 100 shown in FIG. 1. The computer usable medium contains computer usable program code for transmitting information from a musical instrument digital interface file to tactile device 400. The computer usable medium also contains computer usable program code for outputting tactile information from tactile device 400, wherein the tactile information corresponds to the information from the musical instrument digital interface file. Data processing system 100 in FIG. 1 or data processing system 200 in FIG. 2 includes a processor, such as processor 206 in FIG. 2, which is adapted to execute the computer usable code to cause tactile device 400 to adjust one or more pins 402, 404, 406, 408, 410, and/or 412 in response to corresponding information in the musical instrument digital interface file.

Tactile device 400 includes a number of pins, rods, needles, or other objects, such as pin 402, pin 404, pin 406, pin 408, pin 410, and pin 412. Each of pins 402, 404, 406, 408, 410, and 412 are suitable for pressing into the skin of a human without harming the human. Pin 402, 404, 406, 408, 410, and 412 may be further subdivided into a number of additional, smaller pins such that each of pins 402, 404, 406, 408, 410, and 412 can form a cluster of pins.

Tactile device 400 further includes motors, gears, actuators, or any other devices necessary to cause one or more of pins 402, 404, 406, 408, 410, and/or 412 to adjust in response to commands from a processor or controller in device 400 or in some other data processing system. The processor or controller executes the computer usable program code such that tactile device 400 can adjust pins 402, 404, 406, 408, 410, and/or 412 in a manner corresponding to information contained in a musical instrument digital interface file. In addition, tactile device may be provided with computer usable program code such that tactile device 400 can adjust pins 402, 404, 406, 408, 410, and/or 412 in a manner corresponding to information contained in any other type of computer usable file.

In this manner, device 400 may press pins onto the human such that the human perceives six, differently-shaped objects. Each object conveys information to the human, and the set of objects can convey a Braille character. Examples of Braille characters, particularly Braille musical notations, are shown in FIG. 8.

In the illustrative example shown, the tactile information conveyed by tactile device 400 can effectively translate information in a musical instrument digital interface file to a tactile format that a human can interpret as musical notation. Each time a new notation occurs in the musical instrument digital interface file, pins 402, 404, 406, 408, 410, and 412 press onto the human in a different pattern to convey the new notation. In this manner, the human can continuously play a musical instrument while continuously reading a series of Braille characters pressed into the human's skin via tactile device 400. In a similar manner, tactile device 400 can be used to translate inforamtion contained in other computer usable files, such as text files, into other types of Braille characters, such as letter or words. Thus, the aspects of the present invention can also be used to allow a blind human to continuously read a book without lifting a finger.

Tactile device 400 can have its own memory, processor, and data communication equipment, such as modem 222 or bus 238 in FIG. 2. For this reason, tactile device 400 can have musical instrument digital interface files downloaded from a network, such as the Internet or a local area netowrk, into tactile device 400. In turn, tactile device 400 can translate the downloaded musical instrument digital interface files into corresponding Braille symbols in real time.

FIG. 5 shows a tactile device for transmitting information from a musical instrument digital interface file, in accordance with an illustrative example of the present invention. Tactile device 500 is similar to tactile device 400 shown in FIG. 5 and operates according to similar principles. However, tactile device 500 has two sets of pins, set 502 and set 504. Set 502 includes six pins, 506, 508, 510, 512, 514, and 516. Set 504 also includes six pins, 518, 520, 522, 524, 526, and 528. As with tactile device 400 in FIG. 4, a number of additional pins can form each pin in tactile device 500. In either case, tactile device 500 can convey to a human two separate musical notations in Braille at any moment in time.

Although tactile device 400 shown in FIG. 4 shows a single set of six pins and tactile device 500 shows two sets of six pins, tactile device 500 may have a different arrangement of pins. For example, tactile device 500 can have more sets of pins. Furthermore, each set of pins can have more or fewer pins. For example, set 502 can have seven or more pins, or could have five or fewer pins. In each case, smaller pins could make up each of the main pins that make up set 502. In an illustrative example, tactile device 500 has three sets of six pins, and each pin has a number of sub-pins. In this way, tactile device 500 can be configured to convey tactile information to a human in any desired manner.

In addition, although tactile device 400 of FIG. 4 and tactile device 500 of FIG. 5 are shown as contained within boxes, the housing of either tactile device 400 or 500 can have any shape. The shape of the tactile device can be conformed to suit an individual human's preference. Thus, the tactile device of the present invention is not limited to boxes or any other particular shape, and can be designed to abut any convenient portion of the human anatomy.

FIG. 6 shows a block diagram of a tactile device, in accordance with an illustrative example of the present invention. Tactile device 600 can be either tactile device 400 shown in FIG. 4, tactile device 500 shown in FIG. 5, or any other tactile device as provided herein.

Tactile device 600 receives data, usually in the form of musical instrument digital interface (MIDI) files, from source 602 through input/output (I/O) 604. Source 602 may be any source capable of storing MIDI files, such as a memory connected to tactile device 600, a data processing system, or data processing systems connected to a network, such as network 102 shown in FIG. 1, the Internet, or any other network. Similarly, input/output 604 can be any suitable input/output system, such as a wireless connection and associated equipment, an Ethernet connection and associated equipment, or any other type of means for providing input and output, such as a firewire, universal serial bus, serial connection, parallel connection, or any other connection.

Tactile device 600 itself includes processor 606. Processor 606 is adapted to analyze data in a musical instrument digital interface file and, based on that data, cause pin actuating mechanism 610 to actuate pins 612 to form a pin configuration. Processor 606 and pin actuating mechansim 610 contain circuitry, hardware and software for causing pins 612 to form a pin configuration. An example of a device that contains a processor and a pin actuating mechanism for forming a pin configuration can be found in Tecu et al., Tactile Display Apparatus, U.S. Pat. No. 6,703,924 (Mar. 9, 2004). Processor 606 can also be a data processing system, such as data processing system 200 shown in FIG. 2, or can be an individual processor, such as processing unit 206 in FIG. 2. Examples of pin configurations for pins 612 are shown in FIG. 8, including those configurations shown at reference numerals 826 and 828. Other pin configurations are possible, depending on how many pins are provided with tactile device 600 and whether each pin has multiple sub-pins.

Optionally, storage device 608 allows tactile device 600 to store a variety of musical instrument digital interface files. Optionally, power source 616, such as one or more batteries, provides power to the various components of tactile device 600. Power source 616 can also be external to tactile device 600.

Additionally, user interface 614 contains hardware and/or software that allows a user to manipulate tactile device 600. Examples of manipulating tactile device 600 include turning on and off power to tactile device 600, selecting a particular musical instrument digital interface to be processed by tactile device 600, connecting to source 602, and manipulating musical instrument digital interface files stored in storage device 614. User interface 616 can also include a display. The display can be a visual display, such as an LCD or other type of screen, for sighted users. The display also should have a number of additional actuating pins for presenting Braille characters to blind users so that blind users can interpret displayed information from tactile device 600 and can input commands to tactile device 600. The display can also be a speaker or other audio source for presenting the user with spoken words, tones, or other audible information.

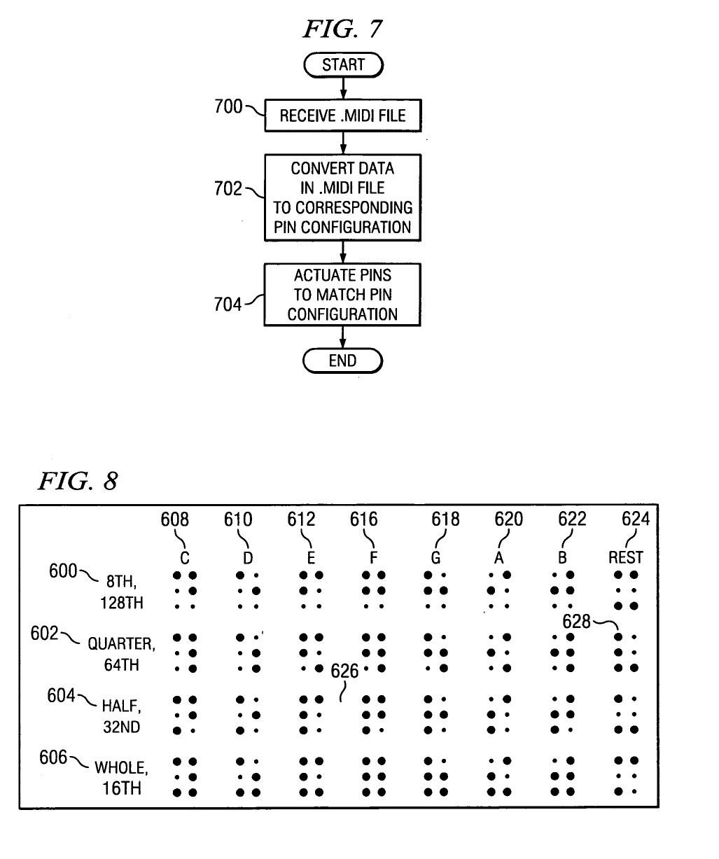

FIG. 7 shows a flowchart of converting data in a MIDI file into a pin configuration in a tactile device, in accordance with an illustrative example of the present invention. The process shown in FIG. 7 can be implemented in any of tactile devices 300, 400, 500, or 600 shown in FIG. 3 through FIG. 6, respectively, using components as described with respect to FIG. 6.

Initially, the tactile device receives a musical instrument digital interface file, which may also be referred to as a MIDI or a MIDI file (step 700). The tactile device then converts data in the musical instrument digital interface file to a corresponding pin configuration, as described with respect to FIG. 6 (step 702). Finally, the tactile device actuates at least one pin to match the pin configuration corresponding to data in the musical instrument digital interface file (step 704). If the exact same pin configuration is to be presented to the user, then the entire set of pins can move outwardly or inwardly in the same configuation to indicate to the user that the previous character is repeated. The process terminates thereafter.

FIG. 8 shows a set of Braille characters representing musical notations. Braille musical notation is known; however, a series of chords and time intervals is shown by way of example. As shown, four time intervals are presented in Braille symbols in rows. The Braille characters in row 800 represent an eighth note time interval; the Braille characters in row 802 represent a quarter note time interval; the Braille characters in row 804 represent a half note time interval; and the Braille characters in row 806 represent a whole note time interval. Each symbol can also represent a fraction equal to 1/16 of the corresponding note interval. The human can interpret the representation of a 1/16 fraction in the context of the flow of musical notations. Thus, the symbols in row 806 can represent 1/16 notes, the symbols in row 804 can represent 1/32 notes, the symbols in row 802 can represent 1/64 notes, and the symbols in row 800 can represent 1/128 notes. In addition, seven chords and a rest are represented in Braille symbols in columns. The Braille characters in column 808 represent a “C” chord; the Braille characters in column 810 represent a “D” chord; the Braille characters in column 812 represent a “E” chord; the Braille characters in column 816 represent a “F” chord; the Braille characters in column 818 represent a “G” chord; the Braille characters in column 820 represent a “A” chord; the Braille characters in column 822 represent a “B” chord; and the Braille characters in column 824 represent a rest. Although seven chords are shown in FIG. 8, different cords can be represented, such as “F sharp minor, diminished one,” or any other known chord.

The intersection of rows and columns shows the Braille symbol for a chord to be played for a particular time interval. Thus, symbol 826 is a Braille symbol that instructs a musician to play an “F” chord for a half note time interval or a 1/32 note time interval, depending on the context of the flow of music symbols. Similarly, symbol 828 is a Braille symbol that instructs a musician to rest for a quarter note time interval or a 1/64 note time interval, depending on the context of the flow of music symbols.

Although FIG. 8 shows a series of symbols for playing chords and rests for given time intervals, other Braille symbols can communicate additional musical notations to a human. For example, Braille symbols are known for representing a note, a chord, a rest, an accidental, a tempo, a time signature, a clef, a key signature, a da capo, dynamics, a fermata, a glissando, a ligature, a trill, and any other form of musical notation. The tactile device of the present invention can adjust the pins of the tactile device such that the human can perceive a Braille symbol that represents any of the forgoing musical symbols. Furthermore, the tactile device of the present invention also can adjust the pins of the tactile device such that the human can perceive standard Braille characters for words or letters in order to convey highly complicated musical instructions to the human.

Thus, the aspects of the present invention provide a computer implemented method, apparatus, and computer program usable program code for transmitting information from a musical instrument digital interface file to a device adapted to provide tactile output. Tactile information is output from the device, wherein the tactile information corresponds to the information from the musical instrument digital interface file.

The tactile device of the present invention has several advantages over known Braille devices. For example, the mechanism of the present invention can translate data in musical instrument digital interface (MIDI) files into Braille characters perceivable by a human. Thus, blind musicians can read music while simultaneously playing a musical instrument.

The invention can take the form of an entirely hardware embodiment, an entirely software embodiment or an embodiment containing both hardware and software elements. In a preferred embodiment, the invention is implemented in both hardware and in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of transmitting musical information comprising:
transmitting information from a musical instrument digital interface file to a device adapted to provide tactile output; and
outputting tactile information from the device, wherein the tactile information corresponds to the information from the musical instrument digital interface file.

2. The method of claim 1 wherein the tactile information corresponds to a Braille character.

3. The method of claim 2 wherein the Braille character corresponds to a musical notation.

4. The method of claim 3 wherein the musical notation is selected from the group consisting of a note, a chord, a rest, an accidental, a tempo, a time signature, a clef, a key signature, a da capo, dynamics, a fermata, a glissando, a ligature, and a trill.

5. The method of claim 1 further comprising:
outputting second tactile information from the device, wherein the second tactile information corresponds to the information from the musical instrument digital interface file.

6. The method of claim 5 wherein the tactile information correspond to a second Braille character.

7. The method of claim 6 wherein the second Braille character corresponds to a second musical notation.

8. The method of claim 7 wherein the second musical notation is selected from the group consisting of a note, a chord, a rest, an accidental, a tempo, a time signature, a clef, a key signature, a da capo, dynamics, a fermata, a glissando, a ligature, and a trill.

9. A computer program product comprising:
a computer usable medium having computer usable program code for transmitting information, said computer program product including:
computer usable program code for transmitting information from a musical instrument digital interface file to a device adapted to provide tactile output; and
computer usable program code for outputting tactile information from the device, wherein the tactile information corresponds to the information from the musical instrument digital interface file.

10. The computer program product of claim 9 wherein the tactile information corresponds to a Braille character.

11. The computer program product of claim 10 wherein the Braille character corresponds to a musical notation.

12. The computer program product of claim 11 wherein the musical notation is selected from the group consisting of a note, a chord, a rest, an accidental, a tempo, a time signature, a clef, a key signature, a da capo, dynamics, a fermata, a glissando, a ligature, and a trill.

13. The computer program product of claim 9 further comprising:
computer usable program code for outputting second tactile information from the device, wherein the second tactile information corresponds to the information from the musical instrument digital interface file.

14. The computer program product of claim 13 wherein the tactile information correspond to a second Braille character.

15. The computer program product of claim 14 wherein the second Braille character corresponds to a second musical notation.

16. The computer program product of claim 15 wherein the second musical notation is selected from the group consisting of a note, a chord, a rest, an accidental, a tempo, a time signature, a clef, a key signature, a da capo, dynamics, a fermata, a glissando, a ligature, and a trill.

17. A device for transmitting information, the device comprising:
a computer usable medium having computer usable program code for transmitting information, said computer program product including:
computer usable program code for transmitting information from a musical instrument digital interface file to a device adapted to provide tactile output; and
computer usable program code for outputting tactile information from the device, wherein the tactile information corresponds to the information from the musical instrument digital interface file; and
a device adapted to provide the tactile output to a receptor, the device in communication with the computer usable medium.

18. The device of claim 17 wherein the receptor is a human and wherein the device further comprises:
a means for securing the device to the human, wherein the means for securing the device to the human is attached to the device.

19. The device of claim 17 wherein the tactile output is provided in the form of a plurality of pins.

20. The device of claim 19 wherein the plurality of pins form a Braille character.
